(19) United States
(12) Patent Application Publication
(10) Pub. No.: US 2024/0281609 A1
(43) Pub. Date: Aug. 22, 2024

(54) METHOD OF TRAINING TEXT RECOGNITION MODEL, AND METHOD OF RECOGNIZING TEXT

(71) Applicant: Beijing Baidu Netcom Science Technology Co., Ltd., Beijing (CN)

(72) Inventors: Pengyuan LV, Beijing (CN); Jingquan LI, Beijing (CN); Chengquan ZHANG, Beijing (CN); Kun YAO, Beijing (CN); Jingtuo LIU, Beijing (CN); Junyu HAN, Beijing (CN)

(21) Appl. No.: 18/041,207

(22) PCT Filed: May 16, 2022
(86) PCT No.: PCT/CN2022/093018

§ 371 Date: Feb. 9, 2023

(30) Foreign Application Priority Data
Aug. 18, 2021 (CN) 202110951785.0

(51) Int. Cl. G06F 40/30; G06V 30/12

(52) U.S. Cl. CPC G06F 40/30; G06V 30/12

(57) ABSTRACT

The present application provides a method of training a text recognition model. The method includes: inputting a first sample image into the visual feature extraction sub-model to obtain a first visual feature and a first predicted text, the first sample image contains a text and a tag indicating a first actual text; obtaining, by using the semantic feature extraction sub-model, a first semantic feature based on the first predicted text; obtaining, by using the sequence sub-model, a second predicted text based on the first visual feature and the first semantic feature; and training the text recognition model based on the first predicted text, the second predicted text and the first actual text. The present disclosure further provides a method of recognizing a text, an electronic device, and a storage medium.

### CROSS-REFERENCE TO RELATED APPLICATION(S)

This application is a Section 371 National Stage Application of International Application No. PCT/CN2022/093018, the PCT application claims priority to Chinese Patent Application No. 202110951785.0 filed on Aug. 18, 2021, which is incorporated herein by reference in its entirety.

### TECHNICAL FIELD

The present disclosure relates to a field of an artificial intelligence technology, in particular to fields of computer vision and deep learning technologies, and may be applied to scenarios such as smart cities and smart finance. Specifically, the present disclosure relates to a method of training a text recognition model, a method of recognizing a text, an electronic device and a storage medium.

### BACKGROUND

A model for a text recognition may recognize a text content according to a visual feature of an image. A semantic model may adjust the text content according to a semantic feature of the text in the image.

### SUMMARY

Based on this, the present disclosure provides a method of training a text recognition model, a method of recognizing a text, an electronic device, and a storage medium.

According to an aspect of the present disclosure, a method of training a text recognition model is provided, the text recognition model includes a visual feature extraction sub-model, a semantic feature extraction sub-model, and a sequence sub-model; the method includes: inputting a first sample image into the visual feature extraction sub-model to obtain a first visual feature and a first predicted text, the first sample image contains a text and a tag indicating a first actual text; obtaining, by using the semantic feature extraction sub-model, a first semantic feature based on the first predicted text; obtaining, by using the sequence sub-model, a second predicted text based on the first visual feature and the first semantic feature; and training the text recognition model based on the first predicted text, the second predicted text and the first actual text.

According to another aspect of the present disclosure, a method of recognizing a text is provided, including: inputting an image to be recognized into a text recognition model, the image to be recognized contains a text; and acquiring the text in the image to be recognized, the text recognition model is trained by using the method of training the text recognition model provided by the present disclosure.

According to another aspect of the present disclosure, an electronic device is provided, including: at least one processor; and a memory communicatively connected to the at least one processor, the memory stores instructions executable by the at least one processor, and the instructions, when executed by the at least one processor, cause the at least one processor to implement the method of training the text recognition model and/or the method of recognizing the text provided by the present disclosure.

According to another aspect of the present disclosure, a non-transitory computer-readable storage medium having computer instructions therein is provided, and the computer instructions are configured to cause a computer to implement the method of training the text recognition model and/or the method of recognizing the text provided by the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 shows a flowchart of a method of training a text recognition model according to an embodiment of the present disclosure;

FIG. 2 shows a flowchart of a method of training a text recognition model according to other embodiments of the present disclosure;

FIG. 3 shows a flowchart of a method of training a text recognition model according to other embodiments of the present disclosure;

FIG. 4 shows a flowchart of a method of training a text recognition model according to other embodiments of the present disclosure;

FIG. 5A shows a schematic diagram of a text recognition model according to an embodiment of the present disclosure;

FIG. 5B shows a schematic diagram of a text recognition model according to other embodiments of the present disclosure;

FIG. 6 shows a flowchart of a method of recognizing a text according to an embodiment of the present disclosure;

FIG. 7 shows a block diagram of an apparatus of training a text recognition model according to an embodiment of the present disclosure:

FIG. 8 shows a block diagram of an apparatus of recognizing a text according to an embodiment of the present disclosure; and

FIG. 9 shows a block diagram of an electronic device for implementing a method of training a text recognition model and/or a method of recognizing a text according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

Models for text recognition include CRNN (Convolutional Recurrent Neural Network) model or ASTER (An Attentional Scene Text Recognizer with Flexible Rectification). The CRNN model or ASTER may recognize a text content only by using a visual feature, and may recognize a text in a normal text image, but has a poor recognition effect for a defective (such as incomplete) image.

Models for semantic feature extraction include SEED (Semantics Enhanced Encoder-Decoder Framework for Scene Text Recognition) and SRN (Spatial Regulation Network) model. The SEED model may supervise a visual feature by using a semantic feature so that the visual feature has a semantic information. However, the SEED model does not merge the semantic feature and the visual feature, and the model does not have a sufficient expression ability for the semantic feature.

The SRN model may enhance a text recognition model by using a semantic feature, which may effectively improve a performance of the text recognition model. However, the SRN model may only use a local semantic feature (such as a single character), and may not use a global semantic feature.

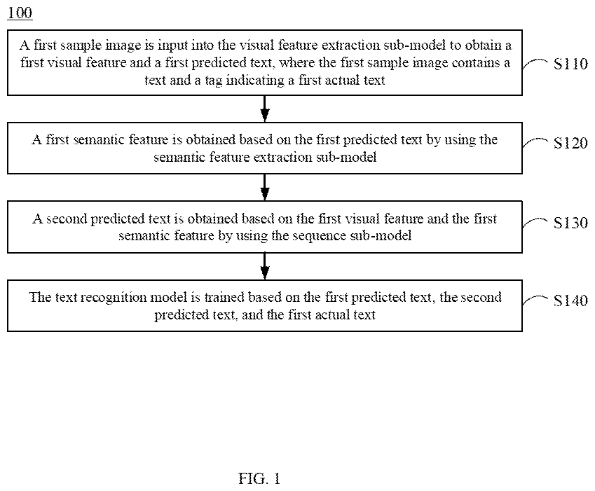

FIG. 1 shows a flowchart of a method of training a text recognition model according to embodiments of the present disclosure.

As shown in FIG. 1, a method 100 of training a text recognition model includes operation S110 to operation S140. The text recognition model includes a visual feature extraction sub-model, a semantic feature extraction sub-model, and a sequence sub-model.

In operation S110, a first sample image is input into the visual feature extraction sub-model to obtain a fast visual feature and a first predicted text. The first sample image contains a text and a tag indicating a first actual text.

For example, the first sample image may be an image of a normal license plate, which contains a non-deformed text. For another example, the first sample image may be an image of a curved license plate, which contains a deformed text.

For example, the first visual feature may include possible characters or possible combinations of characters.

For example, the visual feature extraction sub-model may be the CRNN model or the ASTER model described above, which is not limited in the present disclosure.

In operation S120, a first semantic feature is obtained based on the first predicted text by using the semantic feature extraction sub-model.

For example, the first semantic feature may include a relationship between possible characters. In an example, the relationship between the possible characters may be a relationship between a character and a previous character, and a relationship between a character and a next character.

For example, the semantic feature extraction sub-model may be an RNN (Recurrent Neural Network) model or other sequence models, such as an LSTM (Long Short Term Memory) model, etc. For another example, the semantic feature extraction sub-model may also be a Transformer model, which is not limited in the present disclosure.

In operation S130, a second predicted text is obtained based on the first visual feature and the first semantic feature by using the sequence sub-model.

For example, the second predicted text may be obtained based on the possible characters, the combined possible characters, and the relationship between the possible characters.

It should be understood that the first semantic feature may further include other information, and the first visual feature may further include other information. Obtaining the second predicted text based on the possible characters, the combined possible characters and the relationship between the possible characters in the image is merely one method of obtaining the second predicted text. In other examples, the second predicted text may also be obtained according to other information in the first visual feature and the first semantic feature.

For example, the sequence sub-model may be the aforementioned LSTM model, etc., which is not limited in the present disclosure.

In operation S140, the text recognition model is trained based on the first predicted text, the second predicted text, and the first actual text.

For example, a loss value may be obtained according to the first predicted text and the first actual text, and another loss value may be obtained according to the second predicted text and the first predicted text. A parameter of at least one sub-model selected from the visual feature extraction sub-model, the semantic feature extraction sub-model and the sequence sub-model may be adjusted according to the two loss values to complete a training of the text recognition model. The two loss functions may be the same function or different functions.

Through embodiments of the present disclosure, by merging the visual feature and the semantic feature using the sequence sub-model, it is not required that the predicted text obtained based on the visual feature and another predicted text obtained based on the semantic feature have a same length.

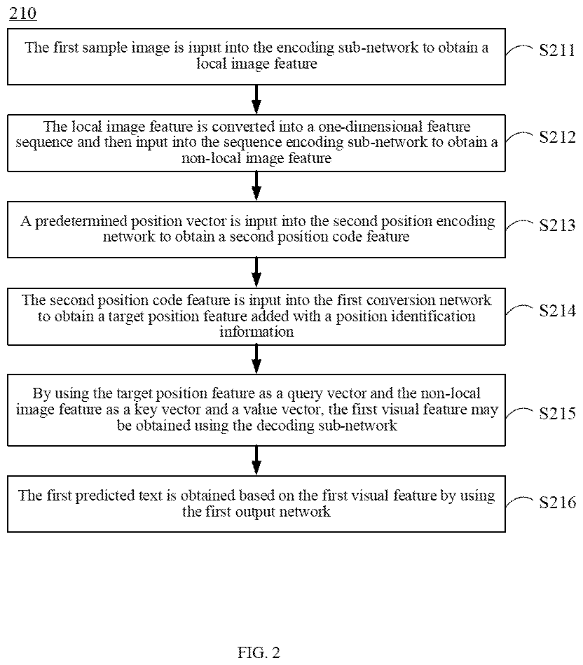

FIG. 2 shows a flowchart of another method of training a text recognition model according to embodiments of the present disclosure.

As shown in FIG. 2, a method 210 of training a text recognition model may include inputting a first sample image containing a text into the visual feature extraction sub-model to obtain a first visual feature and a first predicted text. The visual feature extraction sub-model includes a first feature extraction network and a first output network. The method of training the text recognition model may include operation S211 to operation S216. Specifically, the operations S211 to S216 are a specific implementation of the operation S110 described above.

The method 210 of training the text recognition model may be implemented to input the first sample image into the first feature extraction network to obtain the first visual feature. The first feature extraction network includes an encoding sub-network, a sequence encoding sub-network, and a decoding sub-network.

In operation S211, the first sample image is input into the encoding sub-network to obtain a local image feature.

In embodiments of the present disclosure, the encoding sub-network may be a convolutional neural network.

For example, the encoding sub-network may be a convolutional neural network of any structure, such as VGG, ResNet, DenseNet, and MobileNet. The encoding sub-network may also use some operators to improve a network effect, such as Deformconv, SE, Dilationconv and Inception.

For example, the first sample image may be an H×W picture, and the encoding sub-network may output an h-w local image feature according to the H×W picture.

In operation S212, the local image feature is converted into a one-dimensional feature sequence and then input into the sequence encoding sub-network to obtain a non-local image feature.

In embodiments of the present disclosure, the sequence encoding sub-network may be constructed based on an attention mechanism.

For example, the sequence encoding sub-network may be constructed based on a self-attention mechanism. In an example, the h×w local image feature output by the encoding sub-network is firstly converted into a sequence with a length of k, where k=h*w. The sequence encoding sub-network may output a non-local image feature according to the sequence with the length of k. The sequence encoding sub-network may associate the local image feature with a global image to generate a higher-level feature, that is, the non-local image feature. By providing the sequence encoding network in the visual feature extraction sub-model, an expression ability of the visual feature for a context information may be improved, and thus an accuracy of the obtained first predicted text may be improved.

Next, the method 210 of training the text recognition model may be implemented to obtain the first visual feature based on the non-local image feature by using the decoding sub-network. The visual feature extraction sub-model further includes a second position encoding network.

In operation S213, a predetermined position vector is input into the second position encoding network to obtain a second position code feature.

For example, the predetermined position vector may be a matrix representing position 0 to position 24. It may be understood that a length of the predetermined position vector may be set according to actual needs and is not limited in the present disclosure.

Next, the method of training the text recognition model may be implemented to obtain the first visual feature based on the second position code feature and the non-local image feature by using the decoding sub-network. The visual feature extraction sub-model may further include a first conversion network.

In operation S214, the second position code feature is input into the first conversion network to obtain a target position feature added with a position identification information.

For example, the first conversion network includes at least one fully connected layer, and the second position code feature may be processed by the fully connected layer to be converted into the target position feature. An independent vector may be learned from each position in combination with the position identification information. A length of the text in the first sample image may not exceed a range of the position code.

In operation S215, by using the target position feature as a query vector and the non-local image feature as a key vector and a value vector, the first visual feature may be obtained using the decoding sub-network.

In embodiments of the present disclosure, the decoding sub-network may be constructed based on an attention mechanism.

For example, the decoding sub-network may be constructed based on a parallel attention mechanism (e.g., Multi-Head Attention), and then an input to the decoding sub-network may include a key vector, a value vector and a query vector, so that the accuracy of the extracted non-local image feature may be improved.

In embodiments of the present disclosure, the first visual feature includes a text visual feature and a first global feature obtained by decoding the position identification information.

For example, the decoding sub-network may find possible character features from the non-local feature by using the position identification information, and combine the possible character features to obtain the text visual feature. The decoding sub-network may decode a first global feature containing a global character information from the position identification information. In an example, the decoding sub-network may decode the first global feature according to a vector corresponding to the position 0.

In operation S216, the first predicted text is obtained based on the first visual feature by using the first output network.

In embodiments of the present disclosure, the first output network may obtain the first predicted text based on the text visual feature.

For example, the first output network may include at least one fully connected layer and a Softmax layer. The fully connected layer and the Softmax layer of the first output network may output the first predicted text according to the text visual feature.

In some embodiments, the method may further include pre-training the visual feature extraction sub-model by the following method. A second sample image is input into the visual feature extraction sub-model to obtain a second visual feature and a third predicted text, where the second sample image contains a text and a tag indicating a second actual text. The visual feature extraction sub-model is trained based on the third predicted text and the second actual text. By pre-training the visual feature extraction sub-model, a training efficiency of the text recognition model may be improved.

The second sample image and the first sample image may be selected from a same training dataset, or from different training datasets. For example, the training dataset to which the second sample image belongs may be constructed based on images in a plurality of fields, and the training dataset to which the first sample image belongs may be constructed based on images in a target field in a plurality of fields.

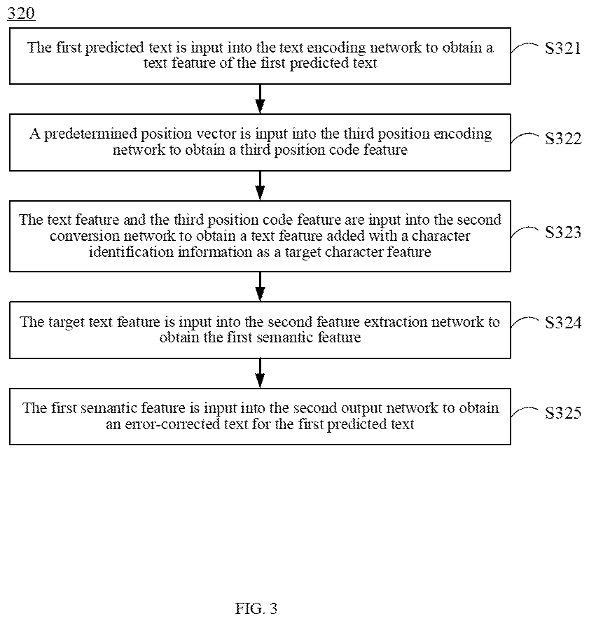

FIG. 3 shows a flowchart of a method of training a text recognition model according to other embodiments of the present disclosure.

As shown in FIG. 3, a method 320 of training a text recognition model may be implemented to obtain a first semantic feature based on the first predicted text by using the semantic feature extraction sub-model. The semantic feature extraction sub-model may include a text encoding network and a second output network. The method 320 of training the text recognition model may include operation S321 to operation S325. Specifically, the operations S321 to S325 are a specific implementation of the operation S120 described above.

In operation S321, the first predicted text is input into the text encoding network to obtain a text feature of the first predicted text.

In embodiments of the present disclosure, the text encoding network may perform One-Hot encoding on the first predicted text to obtain the text feature.

For example, the text encoding network may perform One-Hot encoding on the first predicted text to obtain a matrix of character length C multiplied by N. Each row of the matrix corresponds to a character, and each row of the matrix may be a 1×N vector. In an example, the first sample image may be a deformed text image, such as a deformed text image of “Hello”, and the first predicted text may be “Hallo”. The text feature may be a matrix with 5 rows and N columns, and each row corresponds to a character of the first predicted text “Hallo”.

The semantic feature extraction sub-model further includes a second feature extraction network and a third position encoding network. Next, the method 320 of training the text recognition model may be implemented to obtain the first semantic feature based on the text feature by using the second feature extraction network.

In operation S322, a predetermined position vector is input into the third position encoding network to obtain a third position code feature.

For example, the predetermined position vector may be a matrix representing position 0 to position 24.

Next, the method 320 of training the text recognition model may be implemented to obtain the first semantic feature based on the third position code feature and the text feature by using the second feature extraction network. The semantic feature extraction sub-model further includes a second conversion network.

In operation S323, the text feature and the third position code feature are input into the second conversion network to obtain a text feature added with a character identification information as a target character feature.

In embodiments of the present disclosure, the text feature and the third position code feature may be added, and the character identification information may be added to an initial position of the added feature to obtain a text feature matrix (C+1)×(N+1). The text feature has a size of C×N, and the third position code feature has a size of C, N.

For example, the third position code feature is a matrix with C rows and N columns. The text feature is matrix a,

$$a = [ \begin{matrix}{a}_{1 , 1} & {a}_{1 , 2} & … & {a}_{1 , N} \\ {a}_{2 , 1} & {a}_{2 , 2} & … & ⋮ \\ ⋮ & ⋮ & ⋱ & ⋮ \\ {a}_{C , 1} & … & … & {a}_{C , N}\end{matrix} ]$$

The text feature a is also a matrix with C rows and N columns. Afterwards, the text feature a is added to the third position code feature, and the character identification information is added to the initial position of the added feature to obtain a target text feature a′,

$${a}^{′} = [ \begin{matrix}{a}_{0 , 0} & {a}_{0 , 1} & {a}_{0 , 2} & … & {a}_{0 , N} \\ {a}_{1 , 0} & {a}_{1 , 1}^{′} & {a}_{1 , 2}^{′} & … & {a}_{1 , N}^{′} \\ {a}_{2 , 0} & {a}_{2 , 1}^{′} & {a}_{2 , 2}^{′} & … & ⋮ \\ ⋮ & ⋮ & ⋮ & ⋱ & ⋮ \\ {a}_{C , 0} & {a}_{C , 1}^{′} & … & … & {a}_{C , N}^{′}\end{matrix} ]$$

In an example, C=24.

In embodiments of the present disclosure, the character identification information may be added to an initial position of the text feature, and the text feature added with the character identification information is added to the third position code feature to obtain a text feature matrix (C+1)×(N+1). The text feature has a size of C×N, and the third position code feature has a size of (C+1)×(N+1).

For example, the text feature is matrix a,

$$a = [ \begin{matrix}{a}_{1 , 1} & {a}_{1 , 2} & … & {a}_{1 , N} \\ {a}_{2 , 1} & {a}_{2 , 2} & … & ⋮ \\ ⋮ & ⋮ & ⋱ & ⋮ \\ {a}_{C , 1} & … & … & {a}_{C , N}\end{matrix} ]$$

The character identification information may be firstly added to the text feature a to obtain a text feature a″ added with the character identification information.

$${a}^{″} = [ \begin{matrix}{a}_{0 , 0} & {a}_{0 , 1} & {a}_{0 , 2} & … & {a}_{0 , N} \\ {a}_{1 , 0} & {a}_{1 , 1} & {a}_{1 , 2} & … & {a}_{1 , N} \\ {a}_{2 , 0} & {a}_{2 , 1} & {a}_{2 , 2} & … & ⋮ \\ ⋮ & ⋮ & ⋮ & ⋱ & ⋮ \\ {a}_{C , 0} & {a}_{C , 1} & … & … & {a}_{C , N}\end{matrix} ]$$

The text feature a″ added with the character identification information may be added to the third code position feature to obtain a target text feature a′″,

$${a}^{′′′} = [ \begin{matrix}{a}_{0 , 0}^{″} & {a}_{0 , 1}^{″} & {a}_{0 , 2}^{″} & … & {a}_{0 , N}^{″} \\ {a}_{1 , 0}^{″} & {a}_{1 , 1}^{″} & {a}_{1 , 2}^{″} & … & {a}_{1 , N}^{″} \\ {a}_{2 , 0}^{″} & {a}_{2 , 1}^{″} & {a}_{2 , 2}^{″} & … & ⋮ \\ ⋮ & ⋮ & ⋮ & ⋱ & ⋮ \\ {a}_{C , 0}^{″} & {a}_{C , 1}^{″} & … & … & {a}_{C , N}^{″}\end{matrix} ]$$

The third position code feature is a matrix with (C+1) rows and (N+1) columns.

In an example, C=24.

In operation 324, the target text feature is input into the second feature extraction network to obtain the first semantic feature.

In embodiments of the present disclosure, the first semantic feature includes a text semantic feature and a second global feature obtained by decoding the character identification information.

For example, a relationship between characters may be constructed based on an attention mechanism, so as to obtain the text semantic feature.

For example, the character identification information in the target text feature a′ or a′″ may be decoded to obtain the second global feature. In this way, it is possible to extract a context information between characters with a large span in the first predicted text, and the accuracy of the obtained semantic feature may be improved.

In operation 325, the first semantic feature is input into the second output network to obtain an error-corrected text for the first predicted text.

In embodiments of the present disclosure, the second output network may obtain the error-corrected text for the first predicted text based on the text semantic feature.

For example, the second output network may include at least one fully connected layer and a Softmax layer. The fully connected layer and the Softmax layer of the first output network may output the error-corrected text for the first predicted text according to the text semantic feature.

In some embodiments, the semantic feature extraction sub-model may be pre-trained by the following method. A sample text is input into the semantic feature extraction sub-model to obtain a second semantic feature of the sample text, and the sample text has a tag indicating an actual error-corrected text. The second semantic feature and the position code feature of the sample text are concatenated and input into a predetermined decoding network to obtain a predicted error-corrected text for the sample text. The semantic feature extraction sub-model is trained based on the actual error-corrected text and the predicted error-corrected text.

For example, the semantic feature extraction sub-model may be constructed based on a Transformer model, and the predetermined decoding network may also be constructed based on a Transformer model. After the training is completed, a parameter of the Transformer model corresponding to the semantic feature extraction sub-model may be used as an initial parameter of a corresponding sub-model in the text recognition model. By pre-training the semantic feature extraction sub-model, the training efficiency of the text recognition model may be improved.

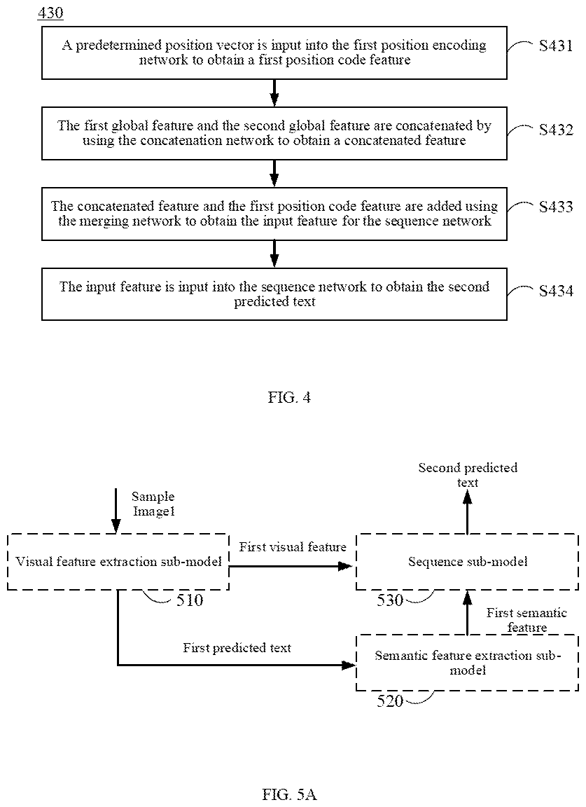

FIG. 4 shows a flowchart of a method of training a text recognition model according to an embodiment of the present disclosure.

As shown in FIG. 4, a method 430 of training a text recognition model may be implemented to obtain a second predicted text based on the first visual feature and the first semantic feature by using the sequence sub-model. The method 430 of training the text recognition model may include operation S431 to operation S434. The sequence sub-model may include a first position encoding network and a sequence network. Specifically, the operations S431 to S434 are a specific implementation of the operation S130 described above.

In operation S431, a predetermined position vector is input into the first position encoding network to obtain a first position code feature.

For example, the predetermined position vector may be a matrix representing position 0 to position 24. By adding the position code feature, the accuracy of the obtained second predicted text may be improved.

Next, the method 430 of training the text recognition model may be implemented to obtain an input feature for the sequence network based on the first visual feature, the first semantic feature and the first position code feature. The sequence sub-model may further include a concatenation network and a merging network.

In embodiments of the present disclosure, features required to obtain the input feature for the sequence network may include: a first global feature in the first visual feature, a second global feature in the first semantic feature, and the first position code feature.

In operation S432, the first global feature and the second global feature are concatenated by using the concatenation network to obtain a concatenated feature.

For example, the first global feature is a 1×M vector, and the second global feature is a 1×N vector. The concatenated feature may be a 1×(M+N) vector. In an example, M=N.

It should be understood that the concatenation network concatenating the first global feature and the second global feature is merely one concatenation method in the present disclosure. The concatenation network may also concatenate the first visual feature and the first semantic feature by using other concatenation methods.

In operation S433, the concatenated feature and the first position code feature are added using the merging network to obtain the input feature for the sequence network.

For example, the concatenated feature may be converted into a matrix with C rows and (M+N) columns. One row in the matrix is the same as the above-mentioned 1×(M+N) vector, and the remaining rows may be filled with a fixed value (such as 0). The matrix converted from the concatenated feature may be added to the first position code feature to obtain the input feature.

In operation S434, the input feature is input into the sequence network to obtain the second predicted text.

For example, a feature of each character may be extracted from the input feature, and decoded using a self-attention mechanism. The feature extracted for each character is processed by at least one fully connected layer and a Softmax layer to obtain the second predicted text.

Through embodiments of the present disclosure, it is avoided to directly perform a weighted summation on corresponding positions of a prediction result of the visual model and a semantic error-corrected result, thereby providing a possibility to reduce errors.

In some embodiments, the features required to obtain the input feature for the sequence network may include: the first visual feature, the first semantic feature, and the first position code feature. The first visual feature includes a text visual feature and a first global feature, and the first semantic feature includes a text semantic feature and a second global feature.

For example, the concatenation network may concatenate at least one of the text visual feature and the first global feature with at least one of the text semantic feature and the second global feature to obtain the concatenated feature. The merging network may merge the concatenated feature with the first position code feature to obtain the input feature for the sequence network.

In some embodiments, training the text recognition model based on the first predicted text, the second predicted text and the first actual text may include: training the text recognition model based on the first predicted text, the second predicted text, an error-corrected text for the first predicted text, and the first actual text. In this way, a model accuracy may be further improved.

Further, in some embodiments, training the text recognition model based on the first predicted text, the second predicted text, the error-corrected text for the first predicted text, and the first actual text may include: obtaining a first loss value based on the first predicted text and the first actual text; obtaining a second loss value based on the second predicted text and the first actual text; obtaining a third loss value based on the error-corrected text for the first predicted text, and the first actual text; and training the text recognition model based on the first loss value, the second loss value and the third loss value.

For example, the first loss function, the second loss function and the third loss function may all use a mean square error (MSE). For another example, the first loss function, the second loss function and the third loss function may all use a square root of the mean square error.

For example, based on the first loss value e₁, the second loss value e₂ and the third loss value e₂, a total loss value E may be calculated according to Equation (1).

$$E = {w}_{1} * {e}_{1} + {w}_{2} * {e}_{2} + {w}_{3} * {e}_{3} \qquad Equation ( 1 )$$

In Equation (1), w₁ represents a weight of the first loss value e₁, w₂ represents a weight of the second loss value e₂, and w₃ represents a weight of the third loss value e₃. In an example, w₁=w₂=0.2, w₃=0.6.

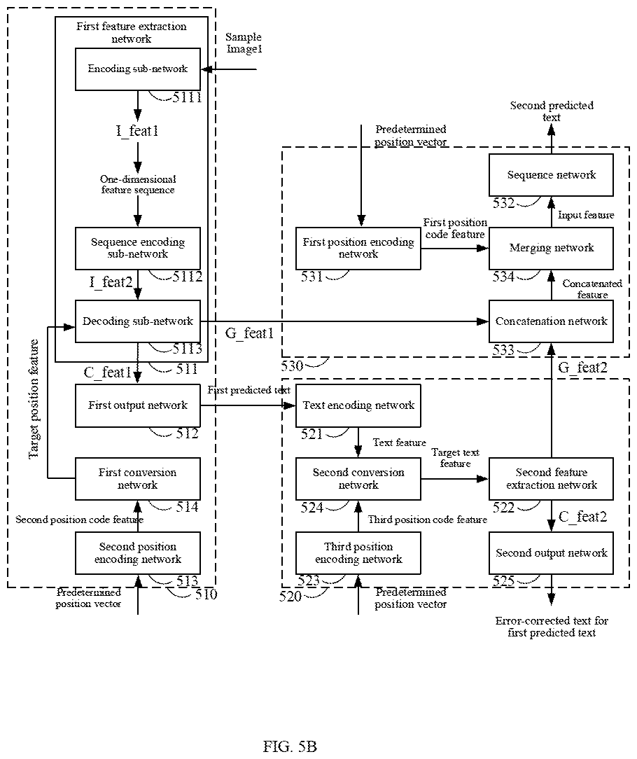

FIG. 5A shows a schematic diagram of a text recognition model according to an embodiment of the present disclosure.

As shown in FIG. 5A, the text recognition model includes a visual extraction sub-model 510, a semantic feature extraction sub-model 520, and a sequence sub-model 530.

The visual extraction sub-model 510 may output a first visual feature and a first predicted text according to a first sample image (Sample Image1). The semantic feature extraction sub-model 520 may output a first semantic feature according to the fast predicted text. The sequence sub-model 530 may output a second predicted text according to the first visual feature and the first semantic feature.

The first sample image contains a text and a tag indicating a first actual text. A loss may be determined according to a difference between the first predicted text and the first actual text; and another loss may be determined according to a difference between the second predicted text and the first actual text. A parameter of at least one sub-model selected from the visual extraction sub-model 510, the semantic feature extraction sub-model 520 and the sequence sub-model 530 may be adjusted according to at least one of the two determined losses, so as to complete this training. The first sample image or other sample images may be input to train multiple times until at least one of the two losses reaches a predetermined value. Alternatively, the first sample image or other sample images may be input to train until a predetermined number of trainings are completed. The first sample image may include a plurality of sample images.

FIG. 5B shows a schematic diagram of a text recognition model according to other embodiments of the present disclosure.

As shown in FIG. 5B, the text recognition model includes a visual extraction sub-model 510, a semantic feature extraction sub-model 520, and a sequence sub-model 530.

The visual extraction sub-model 510 may include a first feature extraction network 511, a first output network 512, a second position encoding network 513, and a first conversion network 514.

The first feature extraction network includes an encoding sub-network 5111, a sequence encoding sub-network 5112, and a decoding sub-network 5113. The encoding sub-network 5111 may output a local image feature I_feat1 according to the first sample image (Sample Image1). The sequence encoding sub-network 5112 may output a non-local image feature I_feat2 according to a one-dimensional feature sequence converted from the local image feature I_feat1.

The second position encoding network 513 may output a second position code feature according to a predetermined position vector. The first conversion network 514 may output a target position feature added with a position identification information according to the second position code feature.

The decoding sub-network 5113 may output a first visual feature according to the target position feature and the non-local image feature I_feat2. The first visual feature includes a text visual features C_feat1 and a first global feature G_feat1. The first output network 512 may output a first predicted text according to the text visual feature C_feat1.

The semantic feature extraction sub-model 520 may include a text encoding network 521, a second feature extraction network 522, a third position code network 523, a second conversion network 524, and a second output network 525.

The text encoding network 521 may output a text feature according to the first predicted text. The third position encoding network 523 may output a third position code feature according to a predetermined position vector. The second conversion network 524 may output a target text feature according to the third position code feature and the text feature. The second feature extraction network 522 may output a first semantic feature according to the target position feature. The first semantic feature includes a text semantic feature C_feat2 and a second global feature G_feat2. The second output network may output an error-corrected text for the first predicted text according to the text semantic feature C_feat2.

The sequence sub-model 530 includes a first position encoding network 531, a sequence network 532, a concatenation network 533, and a merging network 534.

The first position encoding network 531 may output a first position code feature according to a predetermined position vector. The concatenation network 533 may output a concatenated feature according to the first global feature G_feat1 and the second global feature G_feat2. The merging network 534 may output an input feature for the sequence network 532 according to the concatenated feature and the first position code feature. The sequence network 532 may output a second predicted text according to the input feature.

The first sample image contains a text and a tag indicating a first actual text. A first loss value may be determined according to the first predicted text and the first actual text; the second loss value may be determined according to the second predicted text and the first actual text; a third loss value may be determined based on the error-corrected text for the first predicted text and the first actual text. A parameter of at least one sub-model selected from the visual extraction sub-model 510, the semantic feature extraction sub-model 520 and the sequence sub-model 530 or a parameter of at least one network in the sub-model may be adjusted according to at least one of the three determined losses, so as to complete this training. The first sample image or other sample images may be input to train multiple times until at least one of the three loss values reaches a predetermined value. Alternatively, the first sample image or other sample images may be input to train until a predetermined number of trainings are completed.

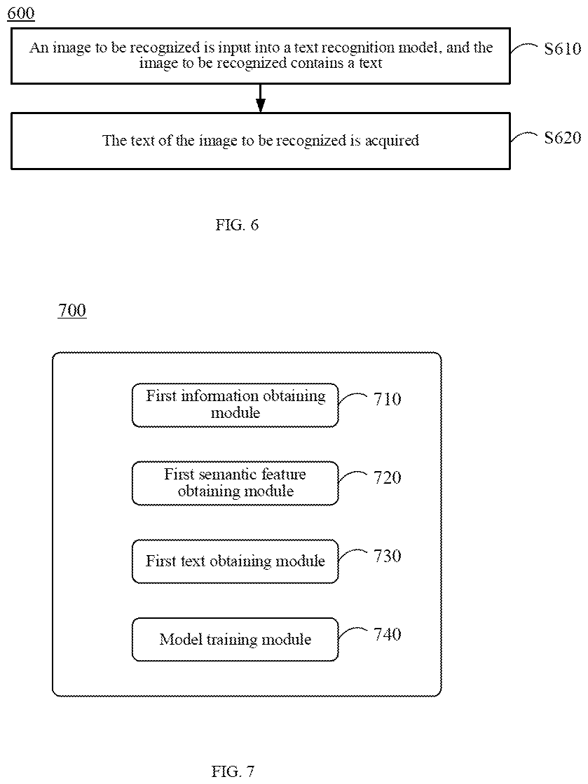

FIG. 6 shows a flowchart of a method of recognizing a text according to an embodiment of the present disclosure.

As shown in FIG. 6, a method 600 of recognizing a text may include operation S610 to operation S620.

In operation S610, an image to be recognized is input into a text recognition model. The image to be recognized contains a text.

For example, the image to be recognized may be an image of a normal license plate, which contains a non-deformed text. For another example, the image to be recognized may be an image of a curved license plate, which contains a deformed text.

In operation S620, the text of the image to be recognized is acquired.

According to embodiments of the present disclosure, the operation S610 may be performed to input the image to be recognized into a text recognition model trained by the method of training the text recognition model described above. The text recognition model may obtain a predicted text using a method similar to that described in operation S110 to operation S130, and the predicted text is used as the text in the image to be recognized.

FIG. 7 shows a block diagram of an apparatus of training a text recognition model according to an embodiment of the present disclosure.

As shown in FIG. 7, an apparatus 700 of training a text recognition model includes a first information obtaining module 710, a first semantic feature obtaining module 720, a first text obtaining module 730, and a model training module 740. The text recognition model includes a visual feature extraction sub-model, a semantic feature extraction sub-model, and a sequence sub-model.

The first information obtaining module 710 may be used to input a first sample image into the visual feature extraction sub-model to obtain a first visual feature and a first predicted text. The first sample image contains a text and a tag indicating a first actual text. In an embodiment, the first information obtaining module 710 may be used to perform operation S110 described above, and details will not be described here.

The first semantic feature obtaining module 720 may be used to obtain, by using the semantic feature extraction sub-model, a first semantic feature based on the first predicted text. In an embodiment, the first semantic feature obtaining module 720 may be used to perform operation S120 described above, and details will not be described here.

The first text obtaining module 730 may be used to obtain, by using the sequence sub-model, a second predicted text based on the first visual feature and the first semantic feature. In an embodiment, the first text obtaining module 730 may be used to perform operation S130 described above, and details will not be described here.

The model training module 740 may be used to train the text recognition model based on the first predicted text, the second predicted text and the first actual text. In an embodiment, the model training module 740 may be used to perform operation S140 described above, and details will not be described here.

In some embodiments, the sequence sub-model includes a first position encoding network and a sequence network. The first text obtaining module includes: a first position code obtaining sub-module used to input a predetermined position vector into the first position encoding network to obtain a first position code feature; an input feature obtaining sub-module used to obtain an input feature for the sequence network based on the first visual feature, the first semantic feature and the first position code feature; and a first text obtaining sub-module used to input the input feature into the sequence network to obtain the second predicted text.

In some embodiments, the visual feature extraction sub-model includes a first feature extraction network and a first output network. The first information obtaining module includes: a first visual feature obtaining sub-module used to input the first sample image into the first feature extraction network to obtain the first visual feature; and a second text obtaining sub-module used to obtain, by using the first output network, the first predicted text based on the first visual feature. The semantic feature extraction sub-model includes a text encoding network and a second feature extraction network. The first semantic feature obtaining module includes: a text feature obtaining sub-module used to input the first predicted text into the text encoding network to obtain a text feature of the first predicted text; and a first visual feature obtaining sub-module used to obtain, by using the second feature extraction network, the first semantic feature based on the text feature.

In some embodiments, the first feature extraction network includes an encoding sub-network, a sequence encoding sub-network, and a decoding sub-network. The first visual feature obtaining sub-module includes: a local image feature obtaining unit used to input the first sample image into the encoding sub-network to obtain a local image feature; a non-local image feature obtaining unit used to convert the local image feature into a one-dimensional feature sequence, and input the one-dimensional feature sequence into the sequence encoding sub-network to obtain a non-local image feature; and a first visual feature obtaining unit used to obtain, by using the decoding sub-network, the first visual feature based on the non-local image feature.

In some embodiments, the visual feature extraction sub-model further includes a second position encoding network. The first visual feature obtaining unit includes: a second position code obtaining sub-unit used to input a predetermined position vector into the second position encoding network to obtain a second position code feature; and a first visual feature obtaining sub-unit used to obtain, by using the decoding sub-network, the first visual feature based on the second position code feature and the non-local image feature; and/or the semantic feature extraction sub-model further includes a third position encoding network; the first semantic feature obtaining sub-module includes: a third position code obtaining unit used to input a predetermined position vector into the third position encoding network to obtain a third position code feature; and a first semantic feature obtaining unit used to obtain, by using the second feature extraction network, the first semantic feature based on the third position code feature and the text feature.

In some embodiments, the visual feature extraction sub-model further includes a first conversion network. The first visual feature obtaining sub-unit includes: a target position feature obtaining sub-unit used to input the second position code feature into the first conversion network to obtain a target position feature added with a position identification information; and a decoding sub-unit used to obtain, by using the target position feature as a query vector and the non-local image feature as a key vector and a value vector, the first visual feature by the decoding sub-network. The semantic feature extraction sub-model further includes a second conversion network. The first semantic feature obtaining unit includes: a target text feature obtaining sub-unit used to input the text feature and the third position code feature into the second conversion network to obtain a text feature added with a character identification information as a target text feature; and a first semantic feature obtaining sub-unit used to input the target text feature into the second feature extraction network to obtain the first semantic feature.

In some embodiments, the first visual feature includes a text visual feature and a first global feature, the first global feature is obtained by decoding the position identification information. The first predicted text is obtained by inputting the text visual feature into the first output network. The first semantic feature includes a text semantic feature and a second global feature, the second global feature is obtained by decoding the character identification information. The input feature obtaining sub-module includes: an input feature obtaining unit used to obtain the input feature for the sequence network based on the first global feature, the second global feature and the first position code feature.

In some embodiments, the sequence sub-model further includes a concatenation network and a merging network. The input feature obtaining unit includes: a concatenation sub-unit used to concatenate, by using the concatenation network, the first global feature and the second global feature to obtain a concatenated feature; and a merging sub-unit used to add, by using the merging network, the concatenated feature and the first position code feature to obtain the input feature for the sequence network.

In some embodiments, the semantic feature extraction sub-model further includes a second output network. The apparatus further includes: an error-corrected text obtaining module used to input the first semantic feature into the second output network to obtain an error-corrected text for the first predicted text. The model training module includes: a first model training sub-module used to train the text recognition model based on the first predicted text, the second predicted text, the error-corrected text for the first predicted text, and the first actual text.

In some embodiments, the first model training sub-module includes: a first loss obtaining unit used to obtain a first loss value based on the first predicted text and the first actual text; a second loss obtaining unit used to obtain a second loss value based on the second predicted text and the first actual text; a third loss obtaining unit used to obtain a third loss value based on the first actual text and the error-corrected text for the first predicted text; and a model training unit used to train the text recognition model based on the first loss value, the second loss value and the third loss value.

In some embodiments, the apparatus further includes a first pre-training module used to pre-train the visual feature extraction sub-model by: an information obtaining sub-module used to input a second sample image into the visual feature extraction sub-model to obtain a second visual feature and a third predicted text, the second sample image contains a text and a tag indicating a second actual text; and a second model training sub-module used to train the visual feature extraction sub-model based on the third predicted text and the second actual text.

In some embodiments, the apparatus further includes a second pre-training module used to pre-train the semantic feature extraction sub-model by: a second semantic feature obtaining sub-module used to input a sample text into the semantic feature extraction sub-model to obtain a second semantic feature of the sample text, the sample text has a tag indicating an actual error-corrected text; an error-corrected text obtaining sub-module used to concatenate and input the second semantic feature and a position code feature of the sample text into a predetermined decoding network to obtain a predicted error-corrected text for the sample text; and a third model training sub-module used to train the semantic feature extraction sub-model based on the actual error-corrected text and the predicted error-corrected text.

FIG. 8 shows a block diagram of an apparatus of recognizing a text according to an embodiment of the present disclosure.

As shown in FIG. 8, an apparatus 800 of recognizing a text includes an image input module 810 and a text acquisition module 820.

The image input module 810 may be used to input an image to be recognized into a text recognition model, and the image to be recognized contains a text. In an embodiment, the image input module 810 may be used to perform operation S610 described above, and details are not described here.

The text acquisition module 820 may be used to acquire the text in the image to be recognized. In an embodiment, the text acquisition module 820 may be used to perform operation S620 described above, and details are not described here.

The text recognition model is trained by using the apparatus of training the text recognition model provided by the present disclosure.

It should be noted that in the technical solutions of the present disclosure, an acquisition, a collection, a storage, a use, a processing, a transmission, a provision, a disclosure and other processing of user personal information involved comply with provisions of relevant laws and regulations, and do not violate public order and good custom.

According to embodiments of the present disclosure, the present disclosure further provides an electronic device, a readable storage medium, and a computer program product.

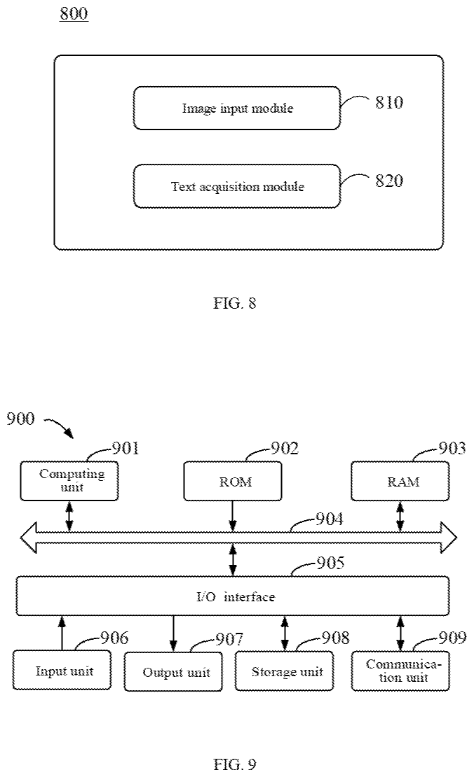

FIG. 9 schematically shows a schematic block diagram of an example electronic device 900 for implementing the method of training the text recognition model and/or the method of recognizing the text of embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 9, the electronic device 900 includes a computing unit 901 which may perform various appropriate actions and processes according to a computer program stored in a read only memory (ROM) 902 or a computer program loaded from a storage unit 908 into a random access memory (RAM) 903. In the RAM 903, various programs and data necessary for an operation of the electronic device 900 may also be stored. The computing unit 901, the ROM 902 and the RAM 903 are connected to each other through a bus 904. An input/output (110) interface 905 is also connected to the bus 904.

A plurality of components in the electronic device 900 are connected to the I/O interface 905, including: an input unit 906, such as a keyboard, or a mouse; an output unit 907, such as displays or speakers of various types; a storage unit 908, such as a disk, or an optical disc; and a communication unit 909, such as a network card, a modem, or a wireless communication transceiver. The communication unit 909 allows the electronic device 900 to exchange information/data with other devices through a computer network such as Internet and/or various telecommunication networks.

The computing unit 901 may be various general-purpose and/or dedicated processing assemblies having processing and computing capabilities. Some examples of the computing units 901 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 901 executes various methods and processes described above, such as the method of training the text recognition model and/or the method of recognizing the text. For example, in some embodiments, the method of training the text recognition model and/or the method of recognizing the text may be implemented as a computer software program which is tangibly embodied in a machine-readable medium, such as the storage unit 908. In some embodiments, the computer program may be partially or entirely loaded and/or installed in the electronic device 900 via the ROM 902 and/or the communication unit 909. The computer program, when loaded in the RAM 903 and executed by the computing unit 901, may execute one or more steps in the method of training the text recognition model and/or the method of recognizing the text described above. Alternatively, in other embodiments, the computing unit 901 may be used to perform the method of training the text recognition model and/or the method of recognizing the text by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback-, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, also known as a cloud computing server or a cloud host, which is a host product in a cloud computing service system to solve shortcomings of difficult management and weak service scalability existing in an existing physical host and VPS (Virtual Private Server) service. The server may also be a server of a distributed system or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

1. A method of training a text recognition model, wherein the text recognition model comprises a visual feature extraction sub-model, a semantic feature extraction sub-model, and a sequence sub-model; the method comprises:
inputting a first sample image into the visual feature extraction sub-model to obtain a first visual feature and a first predicted text, wherein the first sample image contains a text and a tag indicating a first actual text;
obtaining, by using the semantic feature extraction sub-model, a first semantic feature based on the first predicted text;
obtaining, by using the sequence sub-model, a second predicted text based on the first visual feature and the first semantic feature; and
training the text recognition model based on the first predicted text, the second predicted text and the first actual text.

2. The method of claim 1, wherein the sequence sub-model comprises a first position encoding network and a sequence network; the obtaining a second predicted text by using the sequence sub-model comprises:
inputting a predetermined position vector into the first position encoding network to obtain a first position code feature;
obtaining an input feature for the sequence network based on the first visual feature, the first semantic feature and the first position code feature; and
inputting the input feature into the sequence network to obtain the second predicted text.

3. The method of claim 2, wherein:
the visual feature extraction sub-model comprises a first feature extraction network and a first output network; the obtaining a first visual feature and a first predicted text comprises:
inputting the first sample image into the first feature extraction network to obtain the first visual feature; and
obtaining, by using the first output network, the first predicted text based on the first visual feature;
the semantic feature extraction sub-model comprises a text encoding network and a second feature extraction network; the obtaining a first semantic feature by using the semantic feature extraction sub-model comprises:
inputting the first predicted text into the text encoding network to obtain a text feature of the first predicted text; and
obtaining, by using the second feature extraction network, the first semantic feature based on the text feature.

4. The method of claim 3, wherein the first feature extraction network comprises an encoding sub-network, a sequence encoding sub-network, and a decoding sub-network; the inputting the first sample image into the first feature extraction network to obtain the first visual feature comprises:
inputting the first sample image into the encoding sub-network to obtain a local image feature;
converting the local image feature into a one-dimensional feature sequence, and inputting the one-dimensional feature sequence into the sequence encoding sub-network to obtain a non-local image feature; and
obtaining, by using the decoding sub-network, the first visual feature based on the non-local image feature.

5. The method of claim 4, wherein:
the visual feature extraction sub-model further comprises a second position encoding network; the obtaining, by using the decoding sub-network, the first visual feature based on the non-local image feature comprises:
inputting a predetermined position vector into the second position encoding network to obtain a second position code feature; and
obtaining, by using the decoding sub-network, the first visual feature based on the second position code feature and the non-local image feature; and/or
the semantic feature extraction sub-model further comprises a third position encoding network; the obtaining, by using the second feature extraction network, the first semantic feature based on the text feature comprises:
inputting a predetermined position vector into the third position encoding network to obtain a third position code feature; and
obtaining, by using the second feature extraction network, the first semantic feature based on the third position code feature and the text feature.

6. The method of claim 5, wherein:
the visual feature extraction sub-model further comprises a first conversion network; the obtaining the first visual feature by using the decoding sub-network comprises:
inputting the second position code feature into the first conversion network to obtain a target position feature added with a position identification information; and
obtaining, by using the target position feature as a query vector and the non-local image feature as a key vector and a value vector, the first visual feature by the decoding sub-network;
the semantic feature extraction sub-model further comprises a second conversion network; the obtaining the first semantic feature by using the second feature extraction network comprises:
inputting the text feature and the third position code feature into the second conversion network to obtain a text feature added with a character identification information as a target text feature; and
inputting the target text feature into the second feature extraction network to obtain the first semantic feature.

7. The method of claim 6, wherein:
the first visual feature comprises a text visual feature and a first global feature, the first global feature is obtained by decoding the position identification information; the first predicted text is obtained by inputting the text visual feature into the first output network;
the first semantic feature comprises a text semantic feature and a second global feature, the second global feature is obtained by decoding the character identification information; and
the obtaining an input feature for the sequence network based on the first visual feature, the first semantic feature and the first position code feature comprises: obtaining the input feature for the sequence network based on the first global feature, the second global feature and the first position code feature.

8. The method of claim 7, wherein the sequence sub-model further comprises a concatenation network and a merging network; the obtaining the input feature for the sequence network comprises:
concatenating, by using the concatenation network, the first global feature and the second global feature to obtain a concatenated feature; and
adding, by using the merging network, the concatenated feature and the first position code feature to obtain the input feature for the sequence network.

9. The method of claim 3, wherein the semantic feature extraction sub-model further comprises a second output network; and the method further comprises:
inputting the first semantic feature into the second output network to obtain an error-corrected text for the first predicted text;
wherein the training the text recognition model based on the first predicted text, the second predicted text and the first actual text comprises: training the text recognition model based on the first predicted text, the second predicted text, the error-corrected text for the first predicted text, and the first actual text.

10-12. (canceled)

13. A method of recognizing a text, comprising:
inputting an image to be recognized into a text recognition model, wherein the image to be recognized contains a text; and
acquiring the text in the image to be recognized, wherein the text recognition model is trained by using a method of a training a text recognition model, wherein the text recognition model comprises a visual feature extraction sub-model, a semantic feature extraction sub-model, and a sequence sub-model; the method of training a text recognition model comprises operations of:
inputting a first sample image into the visual feature extraction sub-model to obtain a first visual feature and a first predicted text, wherein the first sample image contains a text and a tag indicating a first actual text;
obtaining, by using the semantic feature extraction sub-model, a first semantic feature based on the first predicted text;
obtaining, by using the sequence sub-model, a second predicted text based on the first visual feature and the first semantic feature; and
training the text recognition model based on the first predicted text, the second predicted text and the first actual text.

14-26. (canceled)

27. An electronic device, comprising:
at least one processor; and
a memory communicatively connected to the at least one processor, wherein the memory stores instructions executable by the at least one processor, and the instructions, when executed by the at least one processor, cause the at least one processor to implement a method of recognizing a text, comprising operations of:
inputting an image to be recognized into a text recognition model, wherein the image to be recognized contains a text; and
acquiring the text in the image to be recognized, wherein the text recognition model is trained by using a method of training a text recognition model, wherein the text recognition model comprises a visual feature extraction sub-model, a semantic feature extraction sub-model, and a sequence sub-model; the method of training a text recognition model comprises operations of:
inputting a first sample image into the visual feature extraction sub-model to obtain a first visual feature and a first predicted text, wherein the first sample image contains a text and a tag indicating a first actual text;
obtaining, by using the semantic feature extraction sub-model, a first semantic feature based on the first predicted text;
obtaining, by using the sequence sub-model, a second predicted text based on the first visual feature and the first semantic feature; and
training the text recognition model based on the first predicted text, the second predicted text and the first actual text.

28. A non-transitory computer-readable storage medium having computer instructions therein, wherein the computer instructions are configured to cause a computer to implement the method of claim 1.

29. (canceled)

30. The method of claim 13, wherein the sequence sub-model comprises a first position encoding network and a sequence network; the obtaining a second predicted text by using the sequence sub-model comprises:
inputting a predetermined position vector into the first position encoding network to obtain a first position code feature;
obtaining an input feature for the sequence network based on the first visual feature, the first semantic feature and the first position code feature; and
inputting the input feature into the sequence network to obtain the second predicted text.

31. The method of claim 30, wherein:
the visual feature extraction sub-model comprises a first feature extraction network and a first output network; the obtaining a first visual feature and a first predicted text comprises:
inputting the first sample image into the first feature extraction network to obtain the first visual feature; and
obtaining, by using the first output network, the first predicted text based on the first visual feature;
the semantic feature extraction sub-model comprises a text encoding network and a second feature extraction network; the obtaining a first semantic feature by using the semantic feature extraction sub-model comprises:
inputting the first predicted text into the text encoding network to obtain a text feature of the first predicted text; and
obtaining, by using the second feature extraction network, the first semantic feature based on the text feature.

32. The method of claim 31, wherein the first feature extraction network comprises an encoding sub-network, a sequence encoding sub-network, and a decoding sub-network; the inputting the first sample image into the first feature extraction network to obtain the first visual feature comprises:
inputting the first sample image into the encoding sub-network to obtain a local image feature;
converting the local image feature into a one-dimensional feature sequence, and inputting the one-dimensional feature sequence into the sequence encoding sub-network to obtain a non-local image feature; and
obtaining, by using the decoding sub-network, the first visual feature based on the non-local image feature.

33. The method of claim 32, wherein:
the visual feature extraction sub-model further comprises a second position encoding network; the obtaining, by using the decoding sub-network, the first visual feature based on the non-local image feature comprises:
inputting a predetermined position vector into the second position encoding network to obtain a second position code feature; and
obtaining, by using the decoding sub-network, the first visual feature based on the second position code feature and the non-local image feature; and/or
the semantic feature extraction sub-model further comprises a third position encoding network; the obtaining, by using the second feature extraction network, the first semantic feature based on the text feature comprises:
inputting a predetermined position vector into the third position encoding network to obtain a third position code feature; and
obtaining, by using the second feature extraction network, the first semantic feature based on the third position code feature and the text feature.

34. The method of claim 33, wherein:
the visual feature extraction sub-model further comprises a first conversion network; the obtaining the first visual feature by using the decoding sub-network comprises:
inputting the second position code feature into the first conversion network to obtain a target position feature added with a position identification information; and
obtaining, by using the target position feature as a query vector and the non-local image feature as a key vector and a value vector, the first visual feature by the decoding sub-network;
the semantic feature extraction sub-model further comprises a second conversion network; the obtaining the first semantic feature by using the second feature extraction network comprises:
inputting the text feature and the third position code feature into the second conversion network to obtain a text feature added with a character identification information as a target text feature; and
inputting the target text feature into the second feature extraction network to obtain the first semantic feature.

35. The method of claim 34, wherein:
the first visual feature comprises a text visual feature and a first global feature, the first global feature is obtained by decoding the position identification information; the first predicted text is obtained by inputting the text visual feature into the first output network;
the first semantic feature comprises a text semantic feature and a second global feature, the second global feature is obtained by decoding the character identification information; and
the obtaining an input feature for the sequence network based on the first visual feature, the first semantic feature and the first position code feature comprises: obtaining the input feature for the sequence network based on the first global feature, the second global feature and the first position code feature.

36. The method of claim 35, wherein the sequence sub-model further comprises a concatenation network and a merging network; the obtaining the input feature for the sequence network comprises:
concatenating, by using the concatenation network, the first global feature and the second global feature to obtain a concatenated feature; and
adding, by using the merging network, the concatenated feature and the first position code feature to obtain the input feature for the sequence network.

37. The method of claim 31, wherein the semantic feature extraction sub-model further comprises a second output network; and the method further comprises:
inputting the first semantic feature into the second output network to obtain an error-corrected text for the first predicted text;
wherein the training the text recognition model based on the first predicted text, the second predicted text and the first actual text comprises: training the text recognition model based on the first predicted text, the second predicted text, the error-corrected text for the first predicted text, and the first actual text.
